(19) United States
(12) Patent Application Publication
(10) Pub. No.: US 2016/0109734 A1
(43) Pub. Date: Apr. 21, 2016

(54) ELECTRO-OPTIC PHASE MODULATOR AND MODULATION METHOD

(71) Applicant: IXBLUE, SAINT-GERMAIN-EN-LAYE (FR)

(72) Inventors: Henri PORTE, SERRE LES SAPINS (FR); Nicolas GROSSARD, AUDEUX (FR)

(21) Appl. No.: 14/883,048

(22) Filed: Oct. 14, 2015

(30) Foreign Application Priority Data
Oct. 15, 2014 (FR) 14 59892

(51) Int. Cl. G02F 1/03; G02F 1/035

(52) U.S. Cl. CPC G02F 1/0316; G02F 1/0356; G02F 1/0353

(57) ABSTRACT

The electro-optic phase modulator intended to modulate the optical phase of a lightwave incident on the modulator, includes an electro-optic substrate having an entrance face and an exit face, an optical waveguide of refractive index (n_{g}) higher than that (nₛ) of the substrate, continuously rectilinear from a guide entrance end located on the entrance face to a guide exit end located on the exit face, and which is adapted to guide the incident lightwave partially coupled in the waveguide into a guided lightwave propagating along the optical path of the waveguide between the guide entrance end and exit end, and at least two modulation electrodes arranged parallel to the waveguide, so as, when a modulation voltage (Vₘ(t)) is applied between these modulation electrodes, to introduce a modulation phase-shift, function of the modulation voltage, in the guided lightwave. The phase modulator further includes elements for the electric polarization of the substrate.

### FIELD OF THE INVENTION

The present invention generally relates to the field of optical modulators for controlling light signals.

It more particularly relates to an electro-optic phase modulator intended to modulate the optical phase of a lightwave incident on the modulator.

The invention also relates to a method of modulation for such an electro-optic phase modulator.

### BACKGROUND OF THE INVENTION

An electro-optic phase modulator is an optoelectronic device that allows to control the optical phase of a lightwave that is incident on the modulator and that passes through it, as a function of an electric signal that is applied thereto.

A particular category of electro-optic phase modulators is known from the prior art, referred to as integrated modulators or guided optics modulators, which include:
an electro-optic substrate comprising an entrance face and an exit face,
an optical waveguide which is continuously rectilinear from a guide entrance end located on said entrance face of the substrate to a guide exit end located on said exit face of the substrate, said optical waveguide having an optical refractive index higher than the optical refractive index of the substrate and being adapted to guide said incident lightwave partially coupled in said optical waveguide into a guided lightwave propagating along the optical path of said optical waveguide between said guide entrance end and said guide exit end, and
at least two modulation electrodes arranged parallel to said waveguide, so as, when a modulation voltage is applied between said modulation electrodes, to introduce a modulation phase-shift, function of said modulation voltage, on said guided lightwave propagating in said optical waveguide.

In the present application, an electro-optic substrate is meant to be monobloc, that is made from a single piece. In other words, the electro-optic substrate is not a separate part of a more complex optical structure such as a stack comprising said electro-optic substrate, one or more intermediate layers, and a support for the mechanical strength of said structure.

In the same manner, a continuously rectilinear optical waveguide is meant to be formed by a unique rectilinear segment of waveguide connecting, in only one piece, the guide entrance end to the guide exit end. In particular, the optical waveguide does not comprise any curved portion along its path, and is not continuous piece by piece, that is formed with a plurality of rectilinear segments.

The polarization of the modulation electrodes with the modulation voltage allows, by electro-optic effect in the substrate, to vary the optical refractive index of the waveguide in which the guided lightwave propagates, as a function of this modulation voltage.

This variation of optical refractive index of the waveguide then introduces a modulation phase-shift, phase advance or delay, as a function of the sign of the modulation voltage, on the optical phase of the guided lightwave passing through the waveguide.

This results, at the modulator exit, in a modulation of the optical phase of the incident lightwave.

In theory, such an electro-optic phase modulator modulates only the optical phase of the incident lightwave. So, if a photo-detector is placed on the trajectory of the emerging lightwave at the exit of this modulator, then the optical power (in Watt) measured by this photo-detector will be constant and independent of the modulation phase-shift introduced in the guided lightwave thanks to the modulation electrodes.

In practice, however, the optical power measured is not constant and a low variation of the optical power is detected at the exit of the phase modulator.

This Residual Amplitude Modulation or “RAM” proves, in some cases, to be non-negligible so that the performances of the phase modulator are damaged.

So as to remedy the above-mentioned drawback of the state of the art, the present invention proposes an electro-optic phase modulator allowing to reduce the residual amplitude modulation at the exit of this modulator.

### SUMMARY OF THE INVENTION

For that purpose, the invention relates to an electro-optic phase modulator as defined in the introduction, which, according to the invention, further comprises means for the electric polarization of said electro-optic substrate, adapted to generate in the electro-optic substrate a permanent electric field able to reduce the optical refractive index of said electro-optic substrate in the vicinity of the waveguide.

The device according to the invention hence allows to reduce the coupling between the lightwave guided in the optical waveguide and a lightwave that propagates in a non-optically guided manner in the electro-optic substrate.

Indeed, at the guide entrance end, at the time of injection of the incident lightwave into the optical waveguide, a part of this incident lightwave is not coupled to the waveguide but diffracted at the entrance face, so that a lightwave radiates and then propagates in the substrate in a non-guided manner, out of the waveguide.

This non-guided lightwave has a transverse spatial extension, in a plane that is perpendicular to the waveguide, which, by diffraction, increases up to the exit face of the substrate.

In other words, the light beam associated with the non-guided lightwave has an angular divergence that increases during the propagation of the light beam in the substrate, out of the, the main propagation direction of this diffracted lightwave being defined by the rectilinear segment joining the guide entrance end to the guide exit end.

In other words, this diffracted lightwave propagates in parallel with the rectilinear optical waveguide and in particular travels under the modulation electrodes.

With no particular precaution, it appears that a part of the non-guided lightwave may be coupled with the guided lightwave at the guide exit end, so that these two lightwaves interfere with each other, hence giving rise to the mentioned residual amplitude modulation.

Hence, by generating a permanent electric field in the electro-optic substrate thanks to the electric polarization means, a region is formed near these latter, where the optical refractive index is lower than the optical refractive index of the substrate at rest.

It will be understood herein that the electric field generated by the electric polarization means is permanent in that it disappears as soon as the electric polarization means are no longer supplied.

In the region subjected to the electric field, in the vicinity of the waveguide, no lightwave can propagate anymore so that the non-guided lightwave in the substrate is deviated and moved away from the waveguide.

The reduction of the optical refractive index of the electro-optic substrate affects simultaneously the substrate and the waveguide so that the guidance of the guided lightwave in the waveguide is not much disturbed by the permanent electric field generated by the electric polarization means.

Thanks to the deviation of the non-guided lightwave, the latter does no longer overlap with the guided lightwave at the guide exit end, so that the interferences between the guided lightwave and the non-guided lightwave at the exit of the modulator are considerably reduced.

That way, the residual amplitude modulation is strongly lessen.

Advantageously, said electric polarization means comprise said at least two modulation electrodes that, when an additional polarization voltage is applied between said modulation electrodes in addition to said modulation voltage, are liable to generate said permanent electric field.

Moreover, other advantageous and non-limitative characteristics of the electro-optic phase modulator according to the invention are the following:
said electric polarization means comprise at least two additional electrodes distinct from said modulation electrodes and arranged parallel to said waveguide between said guide entrance end or said guide exit end and said modulation electrodes, said at least two additional electrodes being liable to be polarized by a polarization voltage to generate said permanent electric field;
said at least two additional electrodes being arranged between said guide entrance end and said modulation electrodes, said electric polarization means further comprise at least two other additional electrodes distinct from said modulation electrodes and arranged parallel to said waveguide between said guide exit end and said modulation electrodes, said at least two other additional electrodes being liable to be polarized by another polarization voltage to generate another permanent electric field in the electro-optic substrate adapted to reduce the optical refractive index of said electro-optic substrate in the vicinity of the waveguide;
said electro-optic phase modulator further includes means for coupling said incident lightwave to the guide entrance end and/or means for coupling said guided lightwave to the guide exit end, said coupling means preferably comprising a section of optical fibre;
said electro-optic substrate is of planar geometry, with two lateral faces, a lower face and an upper face, said lower and upper faces extending between said entrance face and said exit face of the substrate and said optical waveguide extending in a plane parallel and close to said upper surface;
said electro-optic substrate is a substrate made of lithium niobate (LiNbO₃), lithium tantalum (LiTaO3), polymer material, semi-conductor material, for example silicon (Si), indium phosphide (InP), or gallium arsenide (GaAs);
the difference (in absolute value) of optical refractive index between said waveguide and said electro-optic substrate is comprised in a range from 10⁻² to 10⁻³;
the difference (in absolute value) of optical refractive index induced in said electro-optic substrate thanks to the electric polarization means is comprised in a range from 10⁻⁵ to 10⁻⁶.

The present invention also relates to an method of modulation for an electro-optic phase modulator according to the invention.

According to the invention, said method of modulation comprises a step of polarizing said electric polarization means adapted to generate a permanent electric field able to reduce the optical refractive index of said electro-optic substrate in the vicinity of said waveguide.

### BRIEF DESCRIPTION OF THE DRAWINGS

The following description with respect to the appended drawings, given by way of non-limitative examples, will allow to well understand in what consists the invention and how it may be made.

In the appended drawings:

FIG. 1 shows a top view of a first embodiment of an electro-optic phase modulator according to the invention including a pair of modulation electrodes and connected at the entrance and at the exit to an optical fibre;

FIG. 2 is a cross-sectional view of the phase modulator of FIG. 1, along a section plane A-A;

FIG. 3 is a longitudinal sectional view of the phase modulator of FIG. 1, along a section plane B-B;

FIG. 4 shows a top view of a second embodiment of an electro-optic phase modulator according to the invention, wherein the phase modulator includes three modulation electrodes;

FIG. 5 shows a top view of a third embodiment of an electro-optic phase modulator according to the invention, including a pair of modulation electrodes and a pair of additional electrodes arranged before the modulation electrodes;

FIG. 6 shows a top view of a fourth embodiment of an electro-optic phase modulator according to the invention, including a pair of modulation electrodes and two pairs of additional electrodes arranged before and after the modulation electrodes;

FIG. 7 is a top view of a variant of the third embodiment of the phase modulator according to the invention of FIG. 5, in which the additional electrodes are placed along a curved portion of the waveguide;

FIG. 8 is a top view of a variant of the fourth embodiment of the phase modulator according to the invention of FIG. 6, in which the two additional pairs of electrodes are placed on two curved portions of the waveguide.

### DETAILED DESCRIPTION OF THE INVENTION

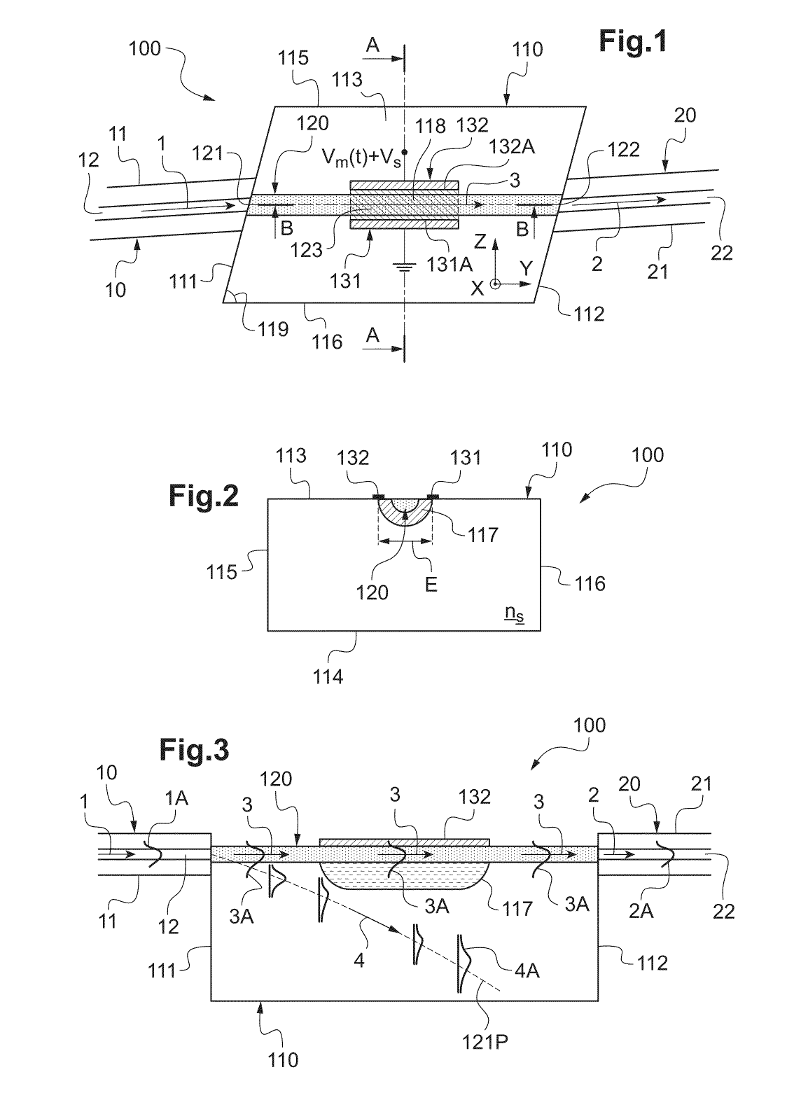

In FIGS. 1 to 8 are shown different embodiments of an electro-optic phase modulator 100, as well as some variants thereof.

Generally, this modulator 100 is intended to modulate the optical phase of a lightwave 1 (herein represented by an arrow, cf. for example FIG. 1) incident on the modulator 100.

Such a modulator 100 finds many applications in optics, in particular in fibre-optic telecommunications for data transmission, in the interferometric sensors for information processing, or in the dynamic control of laser cavities.

The modulator 100 first comprises an electro-optic substrate 110, showing a first-order birefringence induced by a static or variable electric field, also called Pockels effect.

This electro-optic substrate 110 is preferably formed of a lithium niobate crystal, of chemical formula LiNbO₃, this material having a strong Pockels effect.

The substrate 110 has moreover an optical refractive index nₛ comprised between 2.13 and 2.25 for a wavelength range comprised between 400 nanometres (nm) and 1600 nm.

As a variant, the electro-optic substrate of the phase modulator may be a lithium tantalum crystal (LiTaO₃).

As another variant, this electro-optic substrate may be made of a polymer material or a semi-conductor material, for example silicon (Si), indium phosphide (InP) or gallium arsenide (GaAs).

The substrate 110 comprises, on the one hand, an entrance face 111, and on the other hand, an exit face 112. It has herein a planar geometry with two lateral faces 115, 116, a lower face 114 and an upper face 113 (see FIGS. 1 and 2, for example).

The lower face 114 and the upper face 113 hence extend between the entrance face 111 and the exit face 112 of the substrate 110, by being parallel to each other.

Likewise, as shown in FIGS. 1 and 2, the entrance face 111 and the exit face 112 are here again parallel to each other, just like the lateral faces 115, 116.

The substrate 110 has hence the shape of a parallelepiped. Preferably, this parallelepiped is not straight and the substrate 110 is such that the entrance face 111 and one of the lateral faces (here the lateral face 116, see FIG. 1) form an angle 119 lower than 90°, comprised between 80° and 89.9°, for example equal to 85°.

The advantage of such an angle 119 to improve the performances of the phase modulator 100 will be understood in the following of the description.

As shown in FIGS. 2 and 3, the substrate 110 is monobloc and formed from a single crystal of lithium niobate.

The substrate 110 has preferably a thickness, from the lower face 114 to the upper face 113, which is strictly greater than 20 microns. Even more preferably, the thickness of the substrate 110 ranges from 30 microns to 1 millimeter.

Moreover, the substrate 110 has a length from the entrance face 111 to the exit face 112, which is comprised between 10 and 100 millimeters.

Preferably, the substrate 110 has a width, measured between the two lateral faces 115, 116, which is comprised between 0.5 and 100 millimeters.

The substrate 110 of the modulator being herein a lithium niobate crystal, the latter is birefringent (intrinsic birefringence in opposition to the birefringence induced by an electric field), and it is important to precise the geometry and the orientation of this substrate 110 with respect to the axes of this crystal.

In the first, third and fourth embodiments of the invention shown in FIGS. 1 to 3, 5 and 7, and 6 and 8, respectively, the substrate 110 is hence cut along the axis X of the LiNbO₃ crystal, so that the upper face 113 of the substrate 110 is parallel to the plane X-Y of the crystal (see FIG. 1). Still more precisely, the axis Y of the crystal is here oriented parallel to the lateral faces 115, 116 of the electro-optic substrate 110.

By convention, for the lithium niobate, the axis Z is parallel to the axis C or a3 of the crystal lattice. The axis Z is perpendicular to the axis X of the crystal, which is itself parallel to the axis al of the lattice. The axis Y is perpendicular both to the axis Z and to the axis X. The axis Y is turned by 30° with respect to the axis a2 of the lattice, itself oriented at 120° with respect to the axis al and at 90° with respect to the axis a3. The cuts and orientations of the crystal faces generally refer to the axes X, Y and Z.

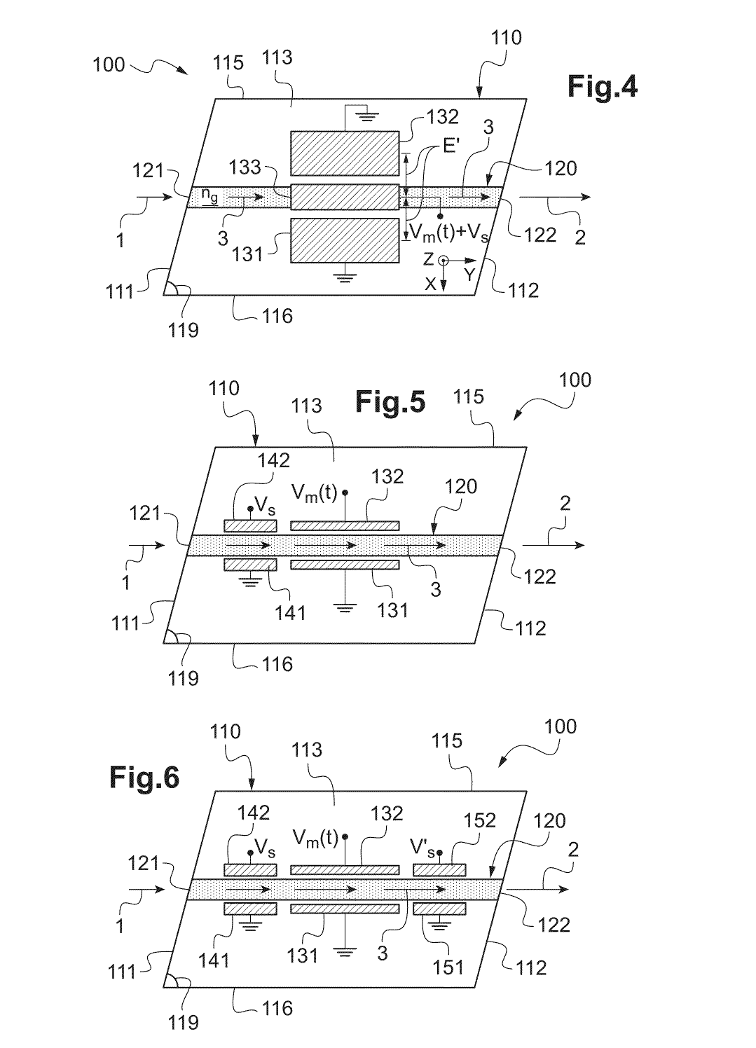

In the second embodiment of the invention shown in FIG. 4, the substrate 110 is cut along the axis Z of the LiNbO₃ crystal, so that the upper face 113 of the substrate 110 is parallel to the plane X-Y of the crystal. Still in this case, the axis Y of the crystal is oriented parallel to the lateral faces 115, 116 of the electro-optic substrate 110.

In all the embodiments, the phase modulator 100 is of the integrated type and comprises a unique optical waveguide 120 that extends rectilinearly in a continuous manner (see FIG. 1 and FIGS. 3 to 8):
from a guide entrance end 121 located on the entrance face 111 of the substrate 110,
to a guide exit end 122 located on the exit face 112 of the substrate 110.

In the planar configuration described, the waveguide 120 extends in a parallel plane that is close to the upper surface 113 of the substrate 110.

In particular herein, as shown for example in FIGS. 2 and 3 for the first embodiment, the waveguide 120 flushes with the upper face 113 of the substrate 110 and has a semi-circular cross-section (see FIG. 2) of radius of 3 to 4 micrometres.

Preferably, the optical waveguide 120 has a length which is comprised between 10 and 100 millimeters.

This waveguide 120 may be made in the lithium niobate substrate 110 by a thermal process of diffusion of titanium in the crystal or by an annealed proton-exchange process, well known by the one skilled in the art.

That way, an optical waveguide 120 is obtained, which shows an optical refractive index n_{g} that is higher than the optical refractive index nₛ of the substrate. If the method of manufacturing of the optical waveguide is the diffusion of titanium, the two refractive indices, ordinary and extra-ordinary, see their value increase. The guide made by diffusion of titanium may then support, i.e. guide, the two states of polarization. If the method of manufacturing the optical waveguide is the proton exchange, in this case, only the extraordinary refractive index sees its value increase, whereas the ordinary refractive index sees its value decrease. The waveguide made by proton exchange can hence support only one state of polarization.

In order to ensure the guidance of the light, this optical refractive index n_{g} of the waveguide 120 must be higher than the optical refractive index nₛ of the substrate 110.

Generally, the higher the difference n_{g}−nₛ of optical refractive index between the waveguide 120 and said electro-optic substrate 110, the higher the confinement of the light.

Advantageously herein, the difference n_{g}−nₛ of optical refractive index between the waveguide 120 and said electro-optic substrate 110 is comprised in a range from 10⁻² to 10⁻³.

In order to modulate the incident lightwave 1, the optical phase modulator 100 also includes modulation means.

In the first, third and fourth embodiments of the invention shown in FIGS. 1 to 3, 5 and 7, and 6 and 8, respectively, where the substrate 110 is cut along the axis X, these modulation means include two modulation electrodes 131, 132 arranged parallel to the waveguide 120, herein on either side of the latter.

In the different embodiments, these modulation electrodes 131, 132 are more precisely arranged around a rectilinear portion 123 of the waveguide 120.

Moreover, as shown in FIG. 1, the two modulation electrodes 131, 132 each comprise an inner edge 131A, 132A turned towards the waveguide 120. They hence define between each other an inter-electrode gap 118 that extends from the inner edge 131A of the first modulation electrode 131 to the inner edge 132A of the second modulation electrode 132.

The two modulation electrodes 131, 132 are spaced apart by a distance E (see FIG. 2) higher than the width of the waveguide 120 at the upper face 113 of the substrate 110, so that the modulation electrodes 131, 132 do not overlap the waveguide 120. The inter-electrode distance E, delimited by the two inner edges 131A, 132A of the modulation electrodes 131, 132, hence corresponds to the transverse dimension, or width, of the inter-electrode gap 118.

For example, the waveguide 120 has herein a width of 3 microns and the inter-electrode distance E is equal to 10 microns.

In the second embodiment of the invention shown in FIG. 4, where the substrate 110 is cut according to the axis Z, the modulation means include three modulation electrodes 131, 132, 133 arranged parallel to said waveguide 120.

The first electrode, or central electrode 133, which has a higher width than that of the waveguide 120, is located above the latter.

The second and third electrodes, or lateral counter-electrodes 131, 132, are for their part located on either side of the waveguide 120, each spaced apart by a distance E′ with respect to the central electrode 133, this distance E′ being determined between the centre of the lateral counter-electrodes 131, 132 and the centre of the central electrode 133.

For example, the waveguide 120 having here a width of 3 microns and the distance E′ between the central electrode 133 and the counter-electrodes 131, 132 is equal to 10 microns.

Conventionally, the modulation electrodes 131, 132, 133 are coplanar and formed on the upper face 133 of the substrate 110 by known techniques of photo-lithography.

The dimensions (width, length, and thickness) of the modulation electrodes 131, 132, 133 are determined as a function of the phase modulation constraints of the modulator, of the nature and the geometry of the substrate 110 (dimensions and orientation), of the width and length of the waveguide 120, and of the performances to be reached.

The modulation electrodes 131, 132, 133 are intended to be polarized by a modulation voltage, herein noted Vₘ(t), the modulation voltage being a voltage varying as a function of time t.

In other words, this modulation voltage Vₘ(t) is applied between the modulation electrodes 131, 132, 133.

For that purpose, one of the modulation electrodes is brought to an electric potential equal to the modulation voltage Vₘ(t) (electrode 132 in the case of the first, third and fourth embodiments, see FIGS. 1, 5 and 6 for example; electrode 133 in the case of the second embodiment, see FIG. 4), whereas the other modulation electrode (electrode 131) or electrodes (electrodes 131, 132) are connected to the ground.

Electric control means (not shown) are provided, which allow to apply to said modulation electrodes 131, 132, 133 the desired set-point (amplitude, frequency . . . ) for the modulation voltage Vₘ(t).

In order to understand the advantages of the invention, the operation of the electro-optic phase modulation 100 will be first briefly described.

The phase modulator 100 is designed to (see FIG. 3):
receive at the entrance the incident lightwave 1 to couple it into a guided lightwave 3,
modulate the optical phase of this guided lightwave 3 propagating rectilinearly in the waveguide 120, and
couple the guided lightwave 3 into an emerging lightwave 2 delivered at the exit of the modulator 100, the optical phase of this emerging lightwave 2 having a modulation similar to that of the guided lightwave 3.

In order to couple at the entrance, and respectively at the exit, the incident lightwave 1, respectively the emerging lightwave 2, the modulator 100 includes means for coupling the incident lightwave 1 at the guide entrance end 121 and means for coupling the emerging lightwave 2 at the guide exit end 122.

These coupling means herein preferably comprise sections 10, 20 of optical fibre (see FIG. 3), for example a silica optical fibre, each comprising a cladding 11, 21 surrounding a core 12, 22 of cylindrical shape in which propagate the incident lightwave 1 (in the core 12) and the emerging lightwave 2 (in the core 22), respectively, each hence having a symmetry of revolution.

By way of example, the amplitude 1A of the incident lightwave 1 propagating in the core 12 of the section 10 of optical fibre and the amplitude 2A of the emerging lightwave 2A propagating in the core 22 of the section 20 of optical fibre are shown in FIG. 3. These amplitudes 1A, 2A correspond to propagation modes in the sections 10, 20 of optical fibre that have a cylindrical symmetry.

In order to perform the coupling, the sections 10, 20 of optical fibre are brought close to the entrance face 111 and to the exit face 112, respectively, so that the core 12, 22 of each section 10, 20 of optical fibre is aligned opposite the guide entrance end 121 and the guide exit end 122, respectively.

Advantageously, it can be provided to use an index-matching glue between the sections 10, 20 of optical fibre and the entrance 111 and exit 112 faces of the substrate 110 in order, on the one hand, to fix said sections 10, 20 of optical fibre to the substrate 110, and on the other hand, to freeze the optical and mechanical alignment between the core 12, 22 of the fibre 10, 20 with respect to the entrance 121 and exit 122 ends of the waveguide 120.

At the entrance, the incident lightwave 1 that propagates along the core 12 of the section 10 of optical fibre towards the substrate 110 is partially coupled in the optical waveguide 120 at the guide entrance end 121 as the guided lightwave 3 (see arrows in FIG. 3).

This guided lightwave 3 then propagates along the continuously rectilinear optical path of the optical waveguide 120 from the guide entrance end 121 to the exit end 122 and has an amplitude 3A such as schematically shown in FIG. 3.

Due to the partial reflections of the guided lightwave 3 on the entrance face 111 and the exit face 112, interferences may be created in the waveguide 120 so that the amplitude 3A of the guided lightwave 3 may show a relatively high residual amplitude modulation.

Nevertheless, thanks to the angle 119 of the substrate 110, this phenomenon of interferences is highly reduced so that the residual amplitude modulation due to these spurious reflections become negligible.

When the electric control means apply the modulation voltage Vₘ(t) between the modulation electrodes 131, 132, 133, an external electric field, proportional to this modulation voltage Vₘ(t), is created in the vicinity of the modulation electrodes 131, 132, 133, more precisely in the region of the substrate 110 and of the waveguide 120 located under the modulation electrodes 131, 132, 133.

By Pockels effect, the optical refractive index n_{g} of the waveguide is modified by this external electric field. As known, the modulation of the optical refractive index is proportional to the amplitude of the external electric field, the coefficient of proportionality depending both on the nature of the material and on the geometry of the modulation electrodes 131, 132, 133.

Moreover, as a function of the orientation of the external electric field with respect to the optical axes of the substrate 110, this variation in the vicinity of the modulation electrodes 131, 132, 133 may be positive or negative, with an increase or a decrease, respectively, of the optical refractive indices nₛ, n_{g} of the substrate 110 and of the waveguide 120.

During the propagation of the guided lightwave 3 in the waveguide 120, this variation of the optical refractive index n_{g} of the waveguide 120 introduces, in the optical phase of the guided lightwave 3 propagating in the optical waveguide 120, a modulation phase-shift that is function of the amplitude of the external electric field and hence of the amplitude of the modulation voltage Vₘ(t) that varies as a function of time t.

As a function of the sign of the modulation voltage Vₘ(t), and hence of the orientation of the external electric field with respect to the optical axes of the substrate 110, this modulation phase-shift may be positive or negative, associated with an optical phase delay or advance, respectively, of the guided lightwave 3.

That way, thanks to the modulation electrodes 131, 132, 133, the optical phase of the guided lightwave 3 may be modulated.

Let's now come back to the coupling of the incident lightwave 1 in the optical waveguide 120.

During this coupling, due to the difference of refractive index spatial distribution between the section 10 of optical fibre and the waveguide 120 in the substrate 110, a part of the incident lightwave 1 is diffracted at the guide entrance end 121, so that a non-guided lightwave 4 in the waveguide 120 (see FIG. 3) propagates in the substrate 110, from the guide entrance end 121 towards the exit face 112 of the substrate 110, with a main direction of propagation 121P which is coplanar with a plane perpendicular with the upper face 113 of the substrate 110 and passing by the middle of the rectilinear waveguide 120.

This non-guided lightwave 4, whose amplitude 4A is shown in FIG. 3, may interfere at the guide exit end 122 with the lightwave 3 guided in the waveguide 120, hence creating a residual amplitude modulation in the emerging lightwave 2 at the exit of the modulator 100.

In order to prevent these interferences and to limit the residual amplitude modulation, the modulator 100 according to the invention comprises means for the electric polarization of the electro-optic substrate 110 to generate, in the latter, a permanent electric field that reduces the optical refractive index nₛ of the substrate 110 in the vicinity of the waveguide 120.

Generally, these electric polarization means comprise electrodes and electric control means to apply, between these electrodes, an electric voltage.

In the first embodiment shown in FIGS. 1 to 3, and in its variant shown in FIG. 4, the electric polarization means comprise the modulation electrodes 131, 132, 133 and the associated electric control means (not shown).

When an additional polarization voltage, noted hereinafter Vₛ, is applied between the modulation electrodes 131, 132, 133 in addition to said modulation voltage Vₘ(t), so that the total voltage applied is equal to Vₘ(t)+V_{S} (cf. FIGS. 1, 3 and 4), a permanent electric field is generated in a region of polarization 117 of the substrate 110 (see FIG. 3) located in the vicinity of the waveguide, near and under the modulation electrodes 131, 132, 133.

This polarization region 117 corresponds in practice to an area of the substrate 110 and of the guide in which the refractive indices nₛ, n_{g} of the substrate 110 and of the waveguide 120 are modulated.

Preferably, this additional polarization voltage Vₛ is constant over time so that the permanent electric field generated in the region of polarization 117 is also constant.

In order to deviate the non-guided lightwave 4 away from the waveguide 120, the additional polarization voltage Vₛ is adjusted so that the permanent electric field in the substrate decreases, by Pockels effect, the optical refractive index nₛ of the electro-optic substrate 110 in the vicinity of the waveguide 120, in the region of polarization 117.

The non-guided lightwave 4 then follows the trajectory 121P represented in dotted line in FIG. 3, a trajectory that deviates from the region of polarization 117 of lower index than the remaining of the substrate 110.

That way, the non-guided lightwave 4 does no longer overlap with the guided lightwave 3 at the guide exit end 122, with the result that they can no longer interfere between each other and lead to a residual amplitude modulation in the emerging lightwave 2 at the exit of the modulator 100.

In practice, with modulation electrodes 131, 132 of 40 millimetre long, spaced apart by 10 micrometres, between which a polarization voltage of 5 to 10 volts is applied, the residual amplitude modulation is reduced by more than 10 decibels.

Advantageously, the permanent electric field generated by the electric polarization means are such that the difference of optical refractive index induced in the electro-optic substrate 110 is comprised in a range from 10⁻⁵ to 10⁻⁶.

Thanks to the electric polarization means, the modulator 100 may implement a modulation method comprising a step of polarization of these electric polarization means.

During this polarization step, the permanent electric field is generated, herein by application of the additional polarization voltage Vₛ, so as to reduce the optical refractive index nₛ of the electro-optic substrate 110 in the vicinity of the waveguide 120.

This step of polarization may advantageously made be at the same time as the step of modulation consisting in applying the modulation voltage Vₘ(t) to the modulation electrodes 131, 132, 133.

In practice, the total voltage Vₘ(t)+Vₛ is applied to said modulation electrodes 131, 132, 133 so as to simultaneously modulate the lightwave 3 guided in the waveguide 120 and deviate the non-guided lightwave 4 towards the lower face 114 of the substrate 110.

Preferably, the amplitude of the additional polarization voltage Vₛ is adjusted, so that the sign, positive or negative, of the total voltage Vₘ(t)+Vₛ applied to the modulation electrodes 131, 132 is constant.

For example, when the modulation voltage Vₘ(t) is a periodic square pulse modulation, taking alternately positive and negative values, for example +1 V and −1 V, an additional polarization voltage Vₛ can be chosen constant and equal to −5V, so that the total voltage Vₘ(t)+Vₛ applied is always negative.

The additional polarization voltage Vₛ being constant, it is associated with an additional optical phase advance or delay of the lightwave 3 guided in the waveguide 120, advance or delay that is hence constant as a function of time. Hence, the application of this additional polarization voltage Vₛ on the modulation electrodes 131, 132 does not disturb the modulation of the optical phase of the guided lightwave 3.

In a second embodiment of the electro-optic phase modulator 100 shown in FIG. 5, the means for the electric polarization of the electro-optic phase modulator 100 comprise two additional electrodes 141, 142, distinct and separated from the modulation electrodes 131, 132, 133.

These polarization electrodes 141, 142 are arranged parallel to the waveguide 120, herein between the guide entrance end 121 and the modulation electrodes 131, 132.

The two additional electrodes 141, 142 are intended to be polarized by a polarization voltage Vₛ applied between them thanks to additional electric control means, to generate a permanent electric field that reduces the optical refractive index n_{g} of the substrate 110 in the vicinity of the waveguide 120, herein in a region of the substrate located under these additional polarization electrodes 141, 142.

By placing these additional electrodes 141, 142 near the guide entrance end 121, it is ensured that the non-guided lightwave 4 is deviated from the beginning of its propagation in the substrate 110.

Tests have shown that, with additional electrodes 141, 142, spaced apart by 10 micrometres from each other and polarized with a polarization voltage Vₛ equal to 5 volts, it was possible to reduce the residual amplitude modulation by at least 10 dB.

However, as a variant, the additional electrodes may be arranged between the guide exit end and the modulation electrodes.

As another variant, the electric polarization means can comprise three additional electrodes arranged in a similar way as the modulation electrodes 131, 132, 133 of FIG. 4, these three additional electrodes being separated from the modulation electrodes.

In order to limit the polarization voltage Vₛ applied to the additional electrodes 141, 142, it can be provided, in a third embodiment of the invention as shown in FIG. 6, that the electric polarization means further comprise two other additional electrodes 151, 152, distinct from the modulation electrodes 131, 132 and arranged parallel to the waveguide 120 between the guide exit end 122 and the modulation electrodes 131, 132.

These two other additional electrodes 151, 152 are liable to be polarized by another polarization voltage V′ₛ to generate another permanent electric field in the electro-optic substrate 110, herein under said two other additional electrodes 151, 152 to reduce the optical refractive index nₛ of said substrate 101 in the vicinity of the waveguide 120.

That way, the non-guided lightwave 4 that propagates in the substrate 110 is doubly deviated and moved away from the guide exit end 122 so that the residual amplitude modulation is still reduced.

With two other additional electrodes 151, 152, identical to the two previously described additional electrodes 141, 142, and by applying polarization voltages Vₛ and V′ₛ each equal to 2.5 V, the residual amplitude modulation is even more reduced.

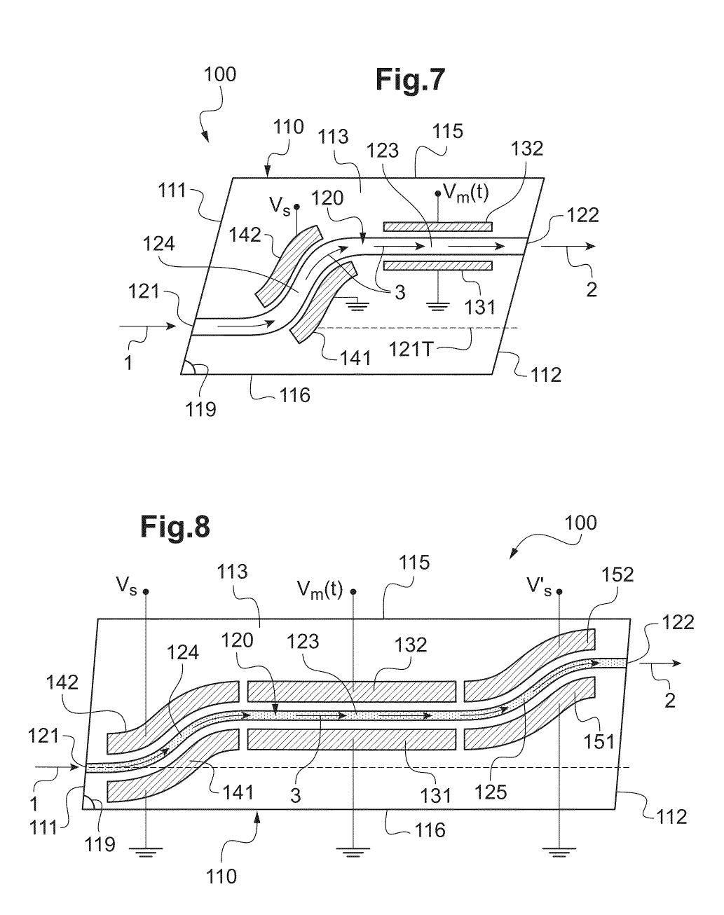

In variants of the second and third embodiments, shown in FIGS. 7 and 8, respectively, the waveguide 120 includes one curved portion 124 and two curved portions 124, 125, respectively.

In this case, the waveguide 120 that extends, in a plane parallel to the upper face 113, between the guide entrance end 121 located on the entrance face 111 of the substrate 110 and the guide exit end 122 located on the exit face 112 of the substrate 110 is hence non-rectilinear.

In the variant of the second embodiment of the electro-optic phase modulator 100 shown in FIG. 7, the guide has a first curved guide portion 124 between the guide entrance end 121 and exit end 122, with the result that the lightwave 3 guided in the waveguide 120 propagates along the optical path of the latter, between the guide entrance end 121 and exit end 122.

In this case, the two additional electrodes 141, 142 of the modulator 100, have then an also-curved shape so as to be arranged parallel to the waveguide 120 at the first curved guide portion 124.

Advantageously, the first curved guide portion 124 has a shape and dimensions selected so as to laterally offset the inter-electrode gap 118 with respect to the direction of propagation of the non-guided lightwave 4.

More precisely, the first curved guide portion 124 is such that the extension of a direction 121T tangent to the waveguide 120 on the entrance face 111 deviates from the inter-electrode gap 118.

In other words, it is advisable, in order to avoid the trapping of the non-guided lightwave 4 in the index modulation area 117, that the refraction plane, associated with the incident lightwave 1 at the entrance of the waveguide 120 and containing in particular the tangent direction 121T, does not intercept the inter-electrode gap 118.

The direction 121T tangent to the waveguide 120 on the entrance face 121 corresponds conventionally to the main direction of refraction of the incident lightwave 1 in the waveguide 120, or more precisely herein to the projection of this main direction on one of the upper 113 or lower 114 faces.

In other words, this tangent direction 121T corresponds to the main direction of propagation of the guided lightwave 3 in the waveguide 120 at the guide entrance end 121. Nevertheless, after being entered into the waveguide 120, the guided lightwave 3 follows the optical path of the waveguide 120 so that it arrives on the exit face 112 at the guide exit end 122.

Likewise, the non-guided lightwave 4 propagates freely in the substrate 110 from the guide entrance end 121 up to the exit face 112 of the substrate 110, with a main direction of propagation 121P (see FIG. 3) coplanar with the tangent direction 121T in the refraction plane.

Hence, from FIG. 7, it is understood that, thanks to the first curved guide portion 124, the non-guided lightwave 4 does no longer pass through the index modulation area 117 that extends in the substrate 110 from the inter-electrode gap 118, so that the non-guided lightwave 4 is no longer guided in the substrate 110, under the modulation electrodes 131, 132.

The non-guided lightwave 4 then propagates in the substrate 110 along the trajectory shown in FIG. 3, even during the application of a modulation voltage Vₘ(t) between the modulation electrodes 131, 132.

During its propagation in the substrate 110, the non-guided lightwave 4 diverges and shows an amplitude 4A that, by diffraction, spreads as the propagation goes along, so that the non-guided lightwave overlaps only partially with the guided lightwave 3 at the guide exit end 122, with the result that they cannot interfere as much between each other and lead to a residual amplitude modulation in the emerging lightwave 2 at the exit of the modulator 100.

The first curved guide portion 124 then introduces a gap between the non-guided lightwave 4 and the inter-electrode gap 118, which is higher than the spatial extension 4A of the non-guided lightwave, in particular at the entrance of the inter-electrode gap 118.

The first curved guide portion 124 has herein a S-shape (see FIG. 5) with two opposite curvatures each having a radius of curvature R_{C} (see FIG. 5), whose value is higher than a predetermined minimum value R_{C,min} so that the optical losses induced by this first curved guide portion 124 are lower than 0.5 dB.

This minimum value R_{C,min} of the radius of curvature is, preferably, higher than or equal to 20 mm.

In order to limit the losses induced by curvatures, it can be provided, in a variant of the third embodiment (see FIG. 8), that the optical waveguide 120 has at least one second curved guide portion 125 between the guide entrance end 121 and the guide exit end 122, herein after the rectilinear guide portion 123.

That way, for a fixed value of the spatial offset between the non-guided lightwave 4 and the index modulation area 117, it is possible to use curved guide portion 124, 125 having lower curvatures and introducing less losses in the modulator 100.

Of course, it is possible to use one or several curved guide portions in the electro-optic phase modulator when the electric polarization means comprise the modulation electrodes of said modulator (case of the first embodiment). This has the advantage to allow the use of a lower additional polarization voltage than when the waveguide has no curved portion.

1. An electro-optic phase modulator (100), intended to modulate the optical phase of a lightwave (1) incident on said modulator (100), including:
an electro-optic substrate (110) comprising an entrance face (111) and an exit face (112),
an optical waveguide (120) continuously rectilinear from a guide entrance end (121) located on said entrance face (111) of the substrate (110) to a guide exit end (122) located on said exit face (112) of the substrate (110), said optical waveguide (120) having an optical refractive index (n_{g}) higher than the optical refractive index (nₛ) of the substrate (110) and being adapted to guide said incident lightwave (1) partially coupled in said optical waveguide (120) into a guided lightwave (3) propagating along the optical path of said optical waveguide (120) between said guide entrance end (121) and exit end (122), and
at least two modulation electrodes (131, 132) arranged parallel to said waveguide (120), so as, when a modulation voltage (Vₘ(t)) is applied between said modulation electrodes (131, 132), to introduce a modulation phase-shift, function of said modulation voltage (Vₘ(t)), on said guided lightwave (3) propagating in said optical waveguide (120),
characterized in that it comprises means (131, 132; 141, 142, 151, 152) for the electric polarization of said electro-optic substrate (110) adapted to generate a permanent electric field in the electro-optic substrate (110) able to reduce the optical refractive index (nₛ) of said electro-optic substrate (110) in the vicinity of the waveguide (120).

2. The electro-optic phase modulator (100) according to claim 1, wherein said electric polarization means comprise said at least two modulation electrodes (131, 132) which, when an additional polarization voltage (Vₛ) is applied between said modulation electrodes (131, 132) in addition to said modulation voltage (Vₘ(t)), are liable to generate said permanent electric field.

3. The electro-optic phase modulator (100) according to claim 1, wherein said electric polarization means comprise at least two additional electrodes (141, 142) distinct from said modulation electrodes (131, 132) and arranged parallel to said waveguide (120) between said guide entrance end (121) or said guide exit end (122) and said modulation electrodes (131, 132), said at least two additional electrodes (141, 142) being liable to be polarized by a polarization voltage (Vₛ) to generate said permanent electric field.

4. The electro-optic phase modulator (100) according to claim 3, wherein said at least two additional electrodes (141, 142) being arranged between said guide entrance end (121) and said modulation electrodes (131, 132), said electric polarization means further comprise at least two other additional electrodes (151, 152) distinct from said modulation electrodes (131, 132) and arranged parallel to said waveguide (120) between said guide exit end (122) and said modulation electrodes (131, 132), said at least two other additional electrodes (151, 152) being liable to be polarized by another polarization voltage (V′ₛ) to generate another permanent electric field in the electro-optic substrate (110) adapted to reduce the optical refractive index (nₛ) of said electro-optic substrate (110) in the vicinity of the waveguide (120).

5. The electro-optic phase modulator (100) according to claim 1, further including means (10) for coupling said incident lightwave (1) to the guide entrance end (121) and/or means (20) for coupling said guided lightwave (3) to the guide exit end (122), said coupling means preferably comprising a section of optical fibre.

6. The electro-optic phase modulator (100) according to claim 1, wherein said electro-optic substrate (110) is of planar geometry, with two lateral faces (115, 116), a lower face (114) and an upper face (113), said lower (114) and upper (113) faces extending between said entrance face (111) and said exit face (112) of the substrate (110) and said optical waveguide (120) extending in a plane parallel and close to said upper surface (113).

7. The electro-optic phase modulator (100) according to claim 1, wherein said electro-optic substrate (110) is a substrate made of lithium niobate, lithium tantalum, polymer material, semi-conductor material, for example silicon, indium phosphide, or gallium arsenide.

8. The electro-optic phase modulator (100) according to claim 1, wherein:
the difference of optical refractive index between said waveguide (120) and said electro-optic substrate (110) is comprised in a range from 10⁻² to 10⁻³, and
the difference of optical refractive index induced in said electro-optic substrate (110) thanks to the electric polarization means is comprised in a range from 10⁻⁵ to 10⁻⁶.

9. A method of modulation for an electro-optic phase modulator (100) according to claim 1, said method of modulation comprising a step of polarizing said electric polarization means (131, 132; 141, 142) adapted to generate a permanent electric field able to reduce the optical refractive index (nₛ) of said electro-optic substrate (110) in the vicinity of said waveguide (120).
